(19) United States
(12) Patent Application Publication
(10) Pub. No.: US 2001/0006896 A1
(43) Pub. Date: Jul. 5, 2001

(54) Mobile unit having a positional alarm

(75) Inventor: Andrew T. Yule, Felbridge (GB)

Correspondence Address: Jack E. Haken, Corporate Patent Counsel, U.S. Philips Corporation, 580 White Plains Road, Tarrytown, NY, 10591, US

(73) Assignee: U.S. PHILIPS CORPORATION

(21) Appl. No.: 09/741,657

(22) Filed: Dec. 19, 2000

(30) Foreign Application Priority Data
Dec. 22, 1999 (GB) 9930305.9

(51) Int. Cl. H04Q 7/20

(52) U.S. Cl. 455/456; 455/432; 455/550; 455/418

(57) ABSTRACT

A mobile unit (1) is disclosed for use with a cellular radio transmission system in the form of a plurality of base stations (BS1 to 7) adapted for two-way radio communication and situated at respective geographical locations to define a corresponding plurality of overlapping service areas (SA1 to 7) constituting one or more regions. The mobile unit comprises a receiver (5), control means (2) for controlling the mobile unit and a user interface (6, 9, 10) wherein the control means is adapted whereby, in use and having pre-programmed the control means with information identifying a predetermined service area, the control means recognizes entry of the mobile unit into that service area from an adjacent service area and notifies a user of the mobile unit of said entry via the user interface. The mobile unit may further comprising a transmitter (5) and be adapted to communicate by two-way radio with the base stations. The user may be notified with an audible, visible or mechanical alarm by the user interface.

This invention relates to a mobile unit having a positional alarm.

It is known to provide a positional alarm in a dedicated mobile receiver wherein the receiver is responsive to the transmissions of any of a number of dedicated transmitters placed at different train stations whereby an audible alarm is sounded upon the receiver approaching a preselected train station. The purpose of such an arrangement is to attract the attention of a user travelling on a train and in possession of such a receiver or, if asleep, wake the user so as to prevent the user missing their selected train stop. However, to work effectively, dedicated transmission infrastructure must be in place at each train station which may be costly. Also, the user must have and carry a dedicated receiver.

It is an object of the present invention to provide a mobile unit with a positional alarm of the type described above, but without reliance on dedicated transmission infrastructure.

According to the present invention, a mobile unit for use with a cellular radio transmission system having a plurality of base stations adapted for two-way radio communication and situated at respective geographical locations to define a corresponding plurality of overlapping service areas constituting one or more regions, the mobile unit comprising a receiver, control means for controlling the mobile unit, means for entering into the control means a predetermined service area, the control means being capable of recognising entry of the mobile unit into the predetermined service area from an adjacent service area, and means for notifying a user of the mobile unit of entry into the predetermined service area.

Such a mobile unit may be used to provide a user with a positional alarm whilst utilising existing cellular radio transmission infrastructure without modification, and thus not the requiring dedicated transmission infrastructure of the prior art. When using existing cellular radio transmission infrastructure, it is convenient if the predetermined service area is identified by the identification code of the corresponding base station.

Ideally, the mobile unit further comprises a transmitter and is adapted to communicate by two-way radio with the base stations. As the invention makes use of conventional cellular radio transmission infrastructure, a two-way mobile communication unit, e.g. a mobile phone, may be readily provided with an integral positioning alarm.

The position may be communicated to the user with an audible, visible or mechanical alarm via the user interface. With respect to an audible or visible alarm, these are especially convenient given that conventional mobile phones normally have a visual display for providing information to the user and an audible alarm for notifying the user of an incoming call.

Preferably, the user may pre-programme the control means via the user interface with information identifying a user selected service area as the predetermined service area.

Either alternatively or in addition, a user may instruct the control means via the user interface to define the current service area as the predetermined service area. This enables the user to set a “home” service area.

Embodiments of the present invention will now be described, by way of example, with reference to the accompanying drawings in which:

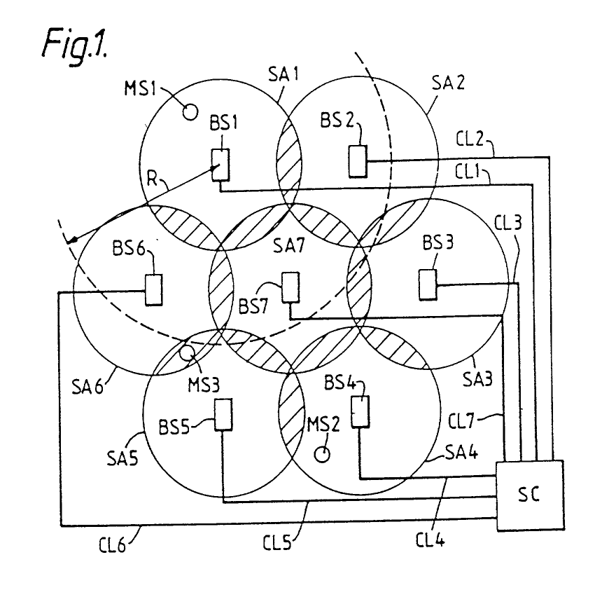

FIG. 1 illustrates diagrammatically the geographical layout of a conventional radio transmission system; and

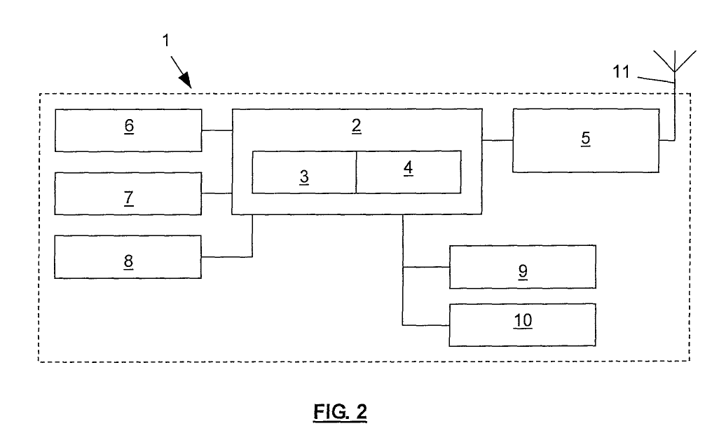

FIG. 2 is a block schematic diagram of an embodiment of a handheld cellular telephone according to the present invention.

The geographical layout of a conventional cellular radio transmission system is illustrated diagrammatically in FIG. 1. The system comprises a plurality of base stations BS of which seven, BS1 to BS7, are shown, situated at respective, mutually spaced geographic locations. Each of these base stations comprises the entirety of a radio transmitter and receiver operated by a trunking system controller at any one site or service area. The respective service areas SA1 to SA7 of these base stations overlap, as shown by the cross hatching, to collectively cover the whole region shown. A plurality of mobile units MS are provided of which three, MS1, MS2 and MS3 are shown. Each mobile unit is free to roam throughout the whole region, and indeed outside it. Each of these mobile units also comprises a radio transmitter/receiver which is capable of communicating with a base station transmitter/receiver when it is within satisfactory communication range of that base station transmitter/receiver, and also comprises means for controlling various operations. The system may furthermore comprise a system controller SC provided with a two-way communication link, CL1 to CL7 respectively, to each base station BS1 to BS7. Each of these communication links may be, for example, a dedicated land-line. The system controller SC may, furthermore, be connected to a the public switched telephone network (PSTN) to enable communication to take place being a mobile unit MS1 and a subscriber to that network. Alternatively, the base stations may be interconnected by a mesh network.

In a known such system, each mobile unit is arranged when operative to register with a base station of which it is within communication range and thereby with the corresponding service area, and to respond to it being no longer within communication range of a base station serving a service area with which it is currently registered by registering with another base station of which it is within such range (if any) and thereby with the corresponding service area. When registered, the mobile unit will be in receipt of an identifying code corresponding to the base station with which it is registered, as indeed base stations are uniquely identified. This enables, inter alia, the mobile unit to distinguish between future broadcasts of the registered base station with those of adjacent base stations with respect to which it is not registered. Of course, such cellular radio systems are well known as are their signalling protocols. In addition, from JP-A-62-179230, it is known for a mobile station to receive a unique identification code of a base station so as to recognise the service area at which it is located at present and to send that positional information to the base station.

Referring to FIG. 2, a cellular telephone 1 according to the present invention and for use with the conventional radio transmission system of FIG. 1 is shown comprising a processor 2 having a central processing unit 3 and memory 4. The processor is coupled to an antenna 11 via a transmitter/receiver 5, to speakers 6 of which one is for use with the telephone ear piece and the other for user notification, to a microphone 7, to a keypad 9, to a display 10 and to a battery 6. As the operation of such a cellular telephone for two-way communication with a base station of a radio transmission system of the type shown in FIG. 1 is entirely conventional, such operation will not be elaborated upon further.

In accordance with the invention, the processor 2 is pre-programmed so as to identify a predetermined service area SA1 by a corresponding base station identification number. The processor is configured to recognise entry of the cellular telephone into that service area from an adjacent service area SA2, SA6 and SA7 and, upon such entry, to sent an instruction signal to the speaker 6 to generate an audible alarm thereby notifying the user. The alarm may be terminated by pressing an appropriate key on the key pad 9.

The user is able to pre-programme the predetermined service area SA by pressing a button on the keypad 9 corresponding to the function of setting the positional alarm. The predetermined service area is then configured to the service area occupied by the user when pressing the button or, if at the time of pressing the button, the telephone is not registered with any base station BS, the service area associated with the next base station that the cellular telephone registers with. Alternatively, the user may pre-programme the predetermined service area by entering an appropriate location code on the keypad whereby that the location code is in some way related to a base station identification number.

Either alternatively or in addition, the alarm may be provided by a graphic or text displayed on the display 10, or by mechanical means such as vibration.

The cellular telephone 1 may for example be used in a scenario in which a user commuting from home to work on a train pre-programmes the predetermined service area to the service area corresponding to the home train station. Upon returning by train, as the user (carrying their cellular phone) approaches the home train station whereby the cellular phone registers with the base station corresponding to the predetermined service area, the alarm is effected. Such an alarm may prevent a user who has either fallen asleep on the train or is not paying attention to the progress of the train from missing their respective stop.

The processor 11 will be typically embedded in an application specific integrated circuit (ASIC), and implementation of the present invention may be accomplished by appropriate microprocessor programming or configuration of such an ASIC. Of course, such programming and configuration is well known and would be accomplished by one of ordinary skill in the art without undue burden.

1. A mobile unit for use with a cellular radio transmission system having a plurality of base stations adapted for two-way radio communication and situated at respective geographical locations to define a corresponding plurality of overlapping service areas constituting one or more regions, the mobile unit comprising a receiver, control means for controlling the mobile unit, means for entering into the control means a predetermined service area, the control means being capable of recognising entry of the mobile unit into the predetermined service area from an adjacent service area, and means for notifying a user of the mobile unit of entry into the predetermined service area.

2. A mobile unit according to claim 1 further comprising a transmitter and adapted to communicate by two-way radio with the base stations.

3. A mobile unit according to claim 1 or claim 2 wherein the predetermined service area is identified by the identification code of the corresponding base station.

4. A mobile unit according to any preceding claim wherein the user is notified by an audible, visible or mechanical alarm.

5. A mobile unit according to any preceding claim comprising user operated means to enter into the control means information identifying a user selected service area as the predetermined service area.

6. A mobile unit according to any preceding claim comprising means for enabling the user to instruct the control means to define the current service area as the predetermined service area.

7. A mobile unit as hereinbefore described with reference to the accompanying drawings.
